(19) United States
(12) Patent Application Publication
(10) Pub. No.: US 2026/0267113 A1
(43) Pub. Date: Sep. 10, 2026

(54) CAMERA MODULE AND A PORTABLE ELECTRONIC DEVICE INCLUDING THE SAME

(71) Applicant: Samsung Electro-Mechanics Co., Ltd., Suwon-si (KR)

(72) Inventor: Hae Seung HYUN, Suwon-si (KR)

(73) Assignee: Samsung Electro-Mechanics Co., Ltd., Suwon-si (KR)

(21) Appl. No.: 19/351,464

(22) Filed: Oct. 7, 2025

(30) Foreign Application Priority Data
Mar. 6, 2025 (KR) 10-2025-0028571

(51) Int. Cl. G02B 7/182; G02B 7/09; G02B 7/18; G03B 17/12; H04N 23/55; H04N 23/57; H04N 23/68; G03B 30/00

(52) U.S. Cl. CPC G02B 7/1821; G02B 7/09; G02B 7/1805; G03B 17/12; H04N 23/55; H04N 23/57; H04N 23/687; G03B 30/00

(57) ABSTRACT

A camera module includes a first lens module including at least one lens disposed in a first optical axis direction and refracting light; a first reflective member disposed to be spaced apart from the first lens module in the first optical axis direction and configured to change a propagation direction of the light; and an image sensor disposed to receive the light. As the first lens module moves upward along the first optical axis direction, a reflective surface of the first reflective member transitions from a first state of being perpendicular to the first optical axis direction to a second state of being oblique to the first optical axis direction.

### CROSS-REFERENCE TO RELATED APPLICATIONS

This application claims the benefit under 35 USC 119(a) of Korean Patent Application No. 10-2025-0028571 filed on Mar. 6, 2025, in the Korean Intellectual Property Office, the entire disclosure of which is incorporated herein by reference for all purposes.

### BACKGROUND

### 1. Field

The present disclosure relates to a camera module.

### 2. Description of the Background

Mobile cameras are becoming more sophisticated. For example, manufacturers have enlarged image sensors to enable a high-magnification zoom function while improving image quality. In some designs, a large-diameter lens is positioned at the front end of a reflective member. However, these improvements may increase the overall height of the camera module, which, when integrated into a mobile device, may cause part of the camera to protrude from the device’s body, potentially affecting its design and usability.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first lens module including at least one lens disposed in a first optical axis direction and refracting light; a first reflective member disposed to be spaced apart from the first lens module in the first optical axis direction and configured to change a propagation direction of the light; and an image sensor disposed to receive the light. As the first lens module moves upward along the first optical axis direction, a reflective surface of the first reflective member transitions from a first state of being perpendicular to the first optical axis direction to a second state of being oblique to the first optical axis direction.

As the first state changes to the second state, a gap between the first lens module and the first reflective member in the first optical axis direction may be maintained.

The camera module further comprising a first structure having a portion extending in the first optical axis direction, wherein one side of the portion is coupled to the first lens module and another side is coupled to the first reflective member.

The first lens module may move along the first optical axis direction together with the first structure, and the first reflective member may be interlocked with the movement of the first lens module and the first structure to displace a portion of the first reflective member in the first optical axis direction.

The first lens module may include a lens holder on which the at least one lens is mounted; a carrier accommodating the lens holder; and a sub-housing accommodating the carrier. The first structure may be coupled to the sub-housing.

The lens holder may be movable in a direction perpendicular to the first optical axis direction with respect to the carrier, and the carrier may be movable in the first optical axis direction, with respect to the sub-housing, together with the lens holder.

One side of the first reflective member may be coupled to the first structure and move together with the first structure, and another side of the first reflective member, disposed in parallel with the one side of the first reflective member, may be fixed to a housing.

A guide groove extending in a second optical axis direction perpendicular to the first optical axis direction may be disposed in the first structure, and a guide protrusion insertable into the guide groove is disposed on the one side of the first reflective member, and as the first structure moves along the first optical axis direction, the guide protrusion may move along the second optical axis direction.

The camera module may further include a second reflective member, as a fixed member, disposed between the first reflective member and the image sensor.

The second reflective member may redirect the light along at least two changes in the propagation direction.

An angle between the reflective surface of the first reflective member and a second optical axis direction, perpendicular to the first optical axis direction, may be greater than an angle between a reflective surface of the second reflective member, which first receives light reflected from the first reflective member, and the second optical axis direction.

The first reflective member may be configured to change the propagation direction of the light from the first optical axis direction to the second optical axis direction, perpendicular to the first optical axis direction. The second reflective member may be configured to change the propagation direction of the light from the second optical axis direction to a third optical axis direction, and from the third optical axis direction to a fourth optical axis direction. The second optical axis direction, the third optical axis direction, and the fourth optical axis direction may not be perpendicular to each other.

An imaging surface of the image sensor may be disposed perpendicular to the fourth optical axis direction.

The camera module may further include a second lens module including at least one lens disposed in a second optical axis direction perpendicular to the first optical axis direction, and refracting light. The second lens module may be movable between the first reflective member and the second reflective member in the second optical axis direction.

The image sensor may be movable in two directions in parallel with an imaging surface of the image sensor and perpendicular to each other.

A portable electronic device may include a front surface and a rear surface spaced apart from each other in a thickness direction, and the camera module above. The camera module may be disposed between the front surface and the rear surface such that the first optical axis direction aligns with the thickness direction, and a protruding amount of the camera module toward either the front surface or the rear surface in the first state is less than a protruding amount of the camera module toward the front surface or the rear surface in the second state.

Other features and aspects will be apparent from the following detailed description, the drawings, and the claims.

### BRIEF DESCRIPTION OF DRAWINGS

FIG. 1 is a conceptual diagram illustrating a pop-out operation of a camera module.

FIG. 2 is a side view of a portable electronic device to which a camera module according to an embodiment of the present disclosure is applied.

FIG. 3 is a schematic cross-sectional view of a camera module (in a collapsed position) according to a first embodiment of the present disclosure.

FIG. 4 is a schematic cross-sectional view of a camera module (in a pop-out position) according to a first embodiment of the present disclosure.

FIG. 5 is a conceptual diagram illustrating a pop-out operation of a camera module according to a second embodiment of the present disclosure.

FIG. 6 is a view illustrating an example of AF and OIS operation of a camera module according to a second embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A camera module according to an embodiment of the present disclosure may be mounted on a portable electronic device. For example, the portable electronic device may be a smartphone, a tablet PC, a notebook computer, or the like, and in addition to those listed above, all types of portable electronic devices may be included therein.

The portable electronic device may include a front surface and a rear surface. In the following description, a thickness direction of the portable electronic device means a direction from the front surface to the rear surface of the portable electronic device, or a direction opposite thereto.

The camera module may be mounted on the portable electronic device, and may be configured to capture an image and/or a video of a subject. Light reflected from the subject may be incident on the camera module in a thickness direction (Y-direction) of the portable electronic device.

A camera module according to an embodiment of the present disclosure may be configured such that a propagation direction of light incident in the thickness direction of a portable electronic device may be changed at least once. The camera module may include a reflective member that changes the propagation direction of light. The reflective member may be a mirror or a prism, and the camera module may include at least one reflective member. Therefore, the camera module may sufficiently increase the propagation path of light despite a limited space of the portable electronic device.

A camera module according to an embodiment of the present disclosure may include at least one lens group. The lens group may include at least one lens that refracts light. At least one lens may be disposed in an optical axis direction. The optical axis may be aligned with the thickness of the portable electronic device, or oriented perpendicular to it - along either the width or length of the device.

A camera module according to an embodiment of the present disclosure may have an auto-focusing function, an optical imaging stabilization function, and a zoom function. These functions may be implemented by moving (including rotating) the lens group or the reflective member.

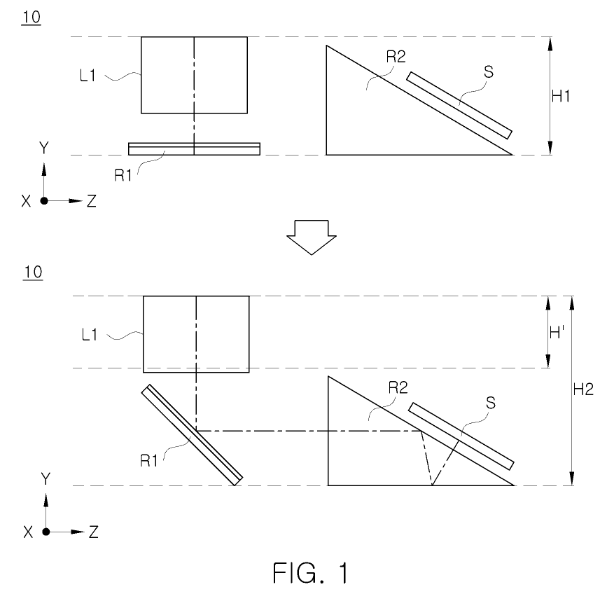

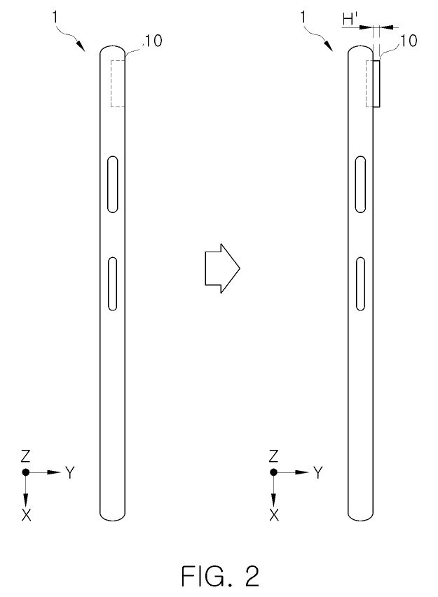

In one or more embodiments of the present disclosure, the camera module may be configured to remain in a collapsed state during normal use, minimizing or eliminating any protrusion from the portable electronic device. When activated for image capture, the module may extend outward from the device. This movement is referred to herein as a "pop-out" operation. The explanation will be further described with reference to FIGS. 1 and 2.

FIG. 1 is a conceptual diagram illustrating a pop-out operation of a camera module. FIG. 2 is a side view of a portable electronic device to which a camera module according to an embodiment of the present disclosure is applied.

Referring to FIG. 1, a height of a camera module 10 in a Y-direction may be changed before or after a pop-out operation. The Y-direction may correspond to a thickness direction of a portable electronic device 1 illustrated in FIG. 2.

The pop-out operation may be implemented by upward movement of components having an optical axis parallel to the Y-direction.

Referring to FIG. 1, the camera module 10 may include a first lens element L1, a first reflective element R1, a second reflective element R2, and an image sensor S, and among these, the first lens element L1 and the first reflective element R1 may perform the pop-out operation.

For example, the first lens element L1 may perform a translational movement such that the first lens element L1 entirely rises and falls in the Y-direction, and the first reflective element R1 may perform a rotational (tilting) movement such that a portion of the first reflective element R1 rises and falls in the Y-direction.

A maximum height of the camera module 10 in the Y-direction before the first lens element L1 and the first reflective element R1 rise may be similar to a thickness of the portable electronic device 1. Therefore, the camera module 10 does not normally protrude (or hardly protrudes) toward a rear surface of the portable electronic device 1.

When shooting, the first lens element L1 and the first reflective element R1 may move upwardly, thereby increasing the maximum height of the camera module 10 in the Y-direction. The camera module 10 may protrude toward the rear surface of the portable electronic device 1 by a height at which the first lens element L1 and the first reflective element R1 rise.

In FIG. 1, H1 may be a maximum height of the camera module 10 in the Y-direction before the first lens element L1 and the first reflective element R1 move upwardly, H2 may be a maximum height of the camera module 10 in the Y-direction after the first lens element L1 and the first reflective element R1 move upwardly, and H’ may be a movement distance (displacement) of the first lens element L1 and the first reflective element R1 in the Y-direction.

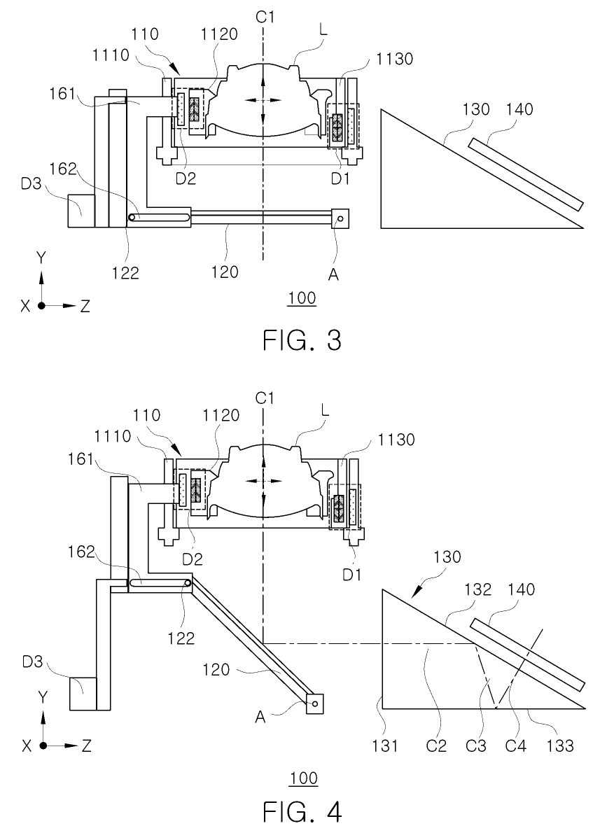

Hereinafter, a camera module according to embodiments of the present disclosure will be described in detail with reference to FIGS. 3-6.

FIG. 3 is a schematic cross-sectional view of a camera module (in a collapsed position) according to a first embodiment of the present disclosure. FIG. 4 is a schematic cross-sectional view of a camera module (in a pop-out position) according to a first embodiment of the present disclosure.

Referring to FIGS. 3 and 4, a camera module 100 may include a lens module 110, a first reflective member 120, a second reflective member 130, an image sensor 140, and a housing (not illustrated) accommodating the same.

Light incident on the camera module 100 may pass through the lens module 110, the first reflective member 120, and the second reflective member 130 in sequence, to reach the image sensor 140.

The lens module 110 may be accommodated in a separate housing (hereinafter, sub-housing) 1110 that may be distinct from the above-mentioned housing, and may be accommodated in the housing, together with the first reflective member 120 or the like.

The lens module 110 may include a lens holder 1120 in which a lens is mounted, and at least one lens L is stacked in an optical axis direction in the lens holder 1120. The at least one lens L may have an optical axis (hereinafter, first optical axis) C1, parallel to the Y-direction.

The lens module 110 may include a carrier 1130. The carrier 1130 may accommodate the lens holder 1120, and may be disposed in the sub-housing 1110.

The lens module 110 may be configured to move during focus adjustment and optical imaging stabilization. During the focus adjustment, the carrier 1130 may move along a first optical axis direction (Y-direction) with respect to the sub-housing 1110. In this case, the lens holder 1120 accommodated in the carrier 1130 may also move together. During the optical imaging stabilization, the lens holder 1120 may move along one or more directions (e.g., X-direction and/or Z-direction), perpendicular to the first optical axis direction (Y-direction), with respect to the carrier 1130.

The lens module 110 may include a driving unit including a magnet and a coil, facing each other. The driving unit may include a first driving unit D1 forming a driving force to move the carrier 1130 in the first optical axis direction (Y-direction), and a second driving unit D2 forming a driving force to move the lens holder 1120 in a direction perpendicular to the first optical axis direction (Y-direction). The second driving unit D2 may be a plurality of second driving units, and directions of the driving forces formed by the driving units may be perpendicular to each other.

The first reflective member 120 may be disposed on an image-side of the lens module 110.

The first reflective member 120 may be a mirror or a prism.

The lens module 110 may be open along the first optical axis direction (Y-direction) such that light incident on the camera module 100 passes through the at least one lens L to be incident on the first reflective member 120. For example, the lens holder 1120, the carrier 1130, and the sub-housing 1110 may all be open in the first optical axis direction (Y-direction). Therefore, the at least one lens L and the first reflective member 120 may be positioned to face each other in the first optical axis direction (Y-direction).

The lens module 110 and the first reflective member 120 may be configured to perform the above-mentioned pop-out operation. According to the pop-out operation, the camera module 100 changes from a collapsed position (or first state) of FIG. 3 to a pop-out position (or second state) of FIG. 4. In the collapsed position of FIG. 3, shooting is not possible. A detailed description of the pop-out operation of the lens module 110 and the first reflective member 120 will be described later.

The second reflective member 130 may be disposed on an image-side of the first reflective member 120. The second reflective member 130 may be a fixed member, which may not move.

The second reflective member 130 may be a slanted prism.

In general, a reflective surface of a reflective member in a camera module may be arranged obliquely at an angle of approximately 45 degrees with respect to an optical axis, so as to change a propagation direction of light by approximately 90 degrees. In contrast, a reflective surface of a slanted prism may be arranged at an angle other than 45 degrees with respect to the optical axis, and the propagation direction of the light may also be altered accordingly.

Referring to FIG. 4, the first reflective member 120 may be a mirror having a reflective surface, and may change a propagation direction of light from the first optical axis direction (Y-direction) to the Z-direction, perpendicular to the first optical axis direction (Y-direction) (hereinafter, a changed optical axis may be referred to as a second optical axis C2). The reflective surface of the first reflective member 120 may be disposed at a 45-degree angle with respect to the first optical axis C1 and the second optical axis C2. The second reflective member 130 may be an oblique prism having a reflective surface. The propagation direction of the light in the second reflective member 130 may be changed two or more successive times. For example, among a plurality of surfaces forming the second reflective member 130, at least two surfaces may function as reflective surfaces. This may increase the total track length (TTL) without increasing the size of the camera module 100.

Referring to FIG. 4, the second reflective member 130 may include a first surface 131, a second surface 132, and a third surface 133.

Light reflected from the first reflective member 130 may be incident on the first surface 131 in a second optical axis direction (Z-direction). The first surface 131 may be perpendicular to the second optical axis C2.

The light may be reflected on the second surface 132 and the third surface 133. The second surface 132 may change the propagation direction of the light from the second optical axis direction (Z-direction) to the third optical axis direction (hereinafter, a changed optical axis may be referred to as a third optical axis C3), and the third surface 133 may change the propagation direction of the light from the third optical axis direction to the fourth optical axis direction (hereinafter, a changed optical axis may be referred to as a fourth optical axis C4).

The second surface 132 may change the propagation direction of the light to 90 degrees or more. For example, the second optical axis C2 and the third optical axis C3 may intersect at an angle, not perpendicular to each other. The second surface 132 may be disposed obliquely at an angle, not 45 degrees, with respect to the second optical axis C2 and the third optical axis C3. For example, an angle formed by the second surface 132 with respect to the second optical axis C2 and the third optical axis C3 may be less than 45 degrees. In an embodiment, a height of the camera module 100 in the Y-direction may be further reduced by adjusting an angle formed by the second surface 132 with respect to the second optical axis C2.

The third surface 133 may change the propagation direction of the light to 90 degrees or less. For example, the third optical axis C3 and the fourth optical axis C4 may also intersect at an angle, not perpendicular to each other, and the third surface 133 may be disposed obliquely at an angle, not 45 degrees with respect to the third optical axis C3 and the fourth optical axis C4. An angle formed by the third surface 133 with the third optical axis C3 and the fourth optical axis C4 may be greater than 45 degrees.

The light reflected from the third surface 133 may be emitted to the second surface 132. For example, the second surface 132 may function as a reflective surface and an emission surface. The second surface 132 may be perpendicular to the fourth optical axis C4.

The light emitted from the second surface 132 may be received by the image sensor 140 disposed behind the second surface 132. The image sensor 140 may be disposed to be parallel to the second surface 132. An imaging surface of the image sensor 140 may be parallel to the second surface 132, perpendicular to the fourth optical axis C4, and oblique to the height direction (Y-direction) of the camera module 100. This structure may have an advantage in that the height of the camera module 100 is reduced compared to a structure in which the imaging surface of the image sensor 140 is disposed in the height direction (Y-direction) of the camera module 100.

In an embodiment, the image sensor 140 may be a fixed member, which may not move. In another embodiment, the image sensor 140 may be configured to move during optical imaging stabilization (sensor shift). For example, the lens module 110 may be in charge of the focus adjustment function, and the image sensor 140 may be in charge of the optical imaging stabilization function. The image sensor 140 may perform optical imaging stabilization while moving in the long and short axis directions of the image sensor 140.

The lens module 110 and the first reflective member 120 may move along the first optical axis direction (Y-direction) by a pop-out operation.

From the perspective of the lens module 110, the pop-out operation may correspond to an upward movement in the Y-direction. As shown in FIGS. 3 and 4, the lens module 110 in the pop-out position may be located at a higher point along the Y-direction than the lens module 110 in the collapsed position. From the perspective of the first reflective member 120, the pop-out operation may correspond to a rotation about an axis A that extends in the X-direction, which is perpendicular to the first optical axis direction (Y-direction). Through this rotation, a reflective surface of the first reflective member 120 transitions from a state in which it lies substantially parallel to the second optical axis C2, to a state in which it is tilted obliquely with respect to the second optical axis C2. In this tilted state, the reflective surface of the first reflective member 120 may be oriented to substantially face a reflective surface of the second reflective member 130 - the second surface 132 of the second reflective member 130 - along the second optical axis direction (Z-direction). The first reflective member 120 may rotate by approximately 45 degrees.

The lens module 110 may move along the first optical axis direction (Y-direction) both during the pop-out operation and during the focus adjustment. However, during the pop-out operation, the lens module 110, including the sub-housing 1110, may be entirely configured to move along the first optical axis direction (Y-direction). By contrast, during the focus adjustment, the carrier 1130 or the like may be configured to move relative to the sub-housing 1110 in the first optical axis direction (Y-direction). In other words, a difference lies in whether the sub-housing 1110 itself moves. In addition, the focus adjustment may be carried out with the lens module 110 in the pop-out position illustrated in FIG. 4.

The camera module 100 may include a driving unit (third driving unit) D3 providing a driving force for the pop-out operation.

For the pop-out operation, the lens module 110 and the first reflective member 120 may be interconnected. The camera module 100 may include a first structure 161 connected to the lens module 110 and the first reflective member 120, respectively. The first structure 161 may include a portion extending in the first optical axis direction (Y-direction) such that a gap between the lens module 110 and the first reflective member 120 is maintained or remains constant.

The lens module 110 may move along the first optical axis direction (Y-direction), together with the first structure 161. The first structure 161 may be coupled to the sub-housing 1110 of the lens module 110. Therefore, during the pop-out operation, the lens module 110 may entirely move along the first optical axis direction (Y-direction), together with the first structure 161.

The first reflective member 120 may be configured to rotate in interlocked with the movement of the lens module 110 and the movement of the first structure 161 in the first optical axis direction (Y-direction).

The first reflective member 120 may be movably coupled to the first structure 161 on one side. For example, the first structure 161 may be provided with a guide groove 162 formed in the second optical axis direction (Z-direction), and the first reflective member 120 may be provided with a guide protrusion 122 inserted into the guide groove. The guide protrusion 122 may move along the second optical axis direction (Z-direction) along the guide groove 162, when the first structure 161 moves along the first optical axis direction (Y-direction). The first reflective member 120 may be fixed to the housing on the other side, and may become the rotational axis A. One side and the other side of the first reflective member 120 may be portions spaced apart in the second optical axis direction (Z-direction). In another embodiment, an extension direction of the guide groove 162 and a position of the rotational axis A may be changed.

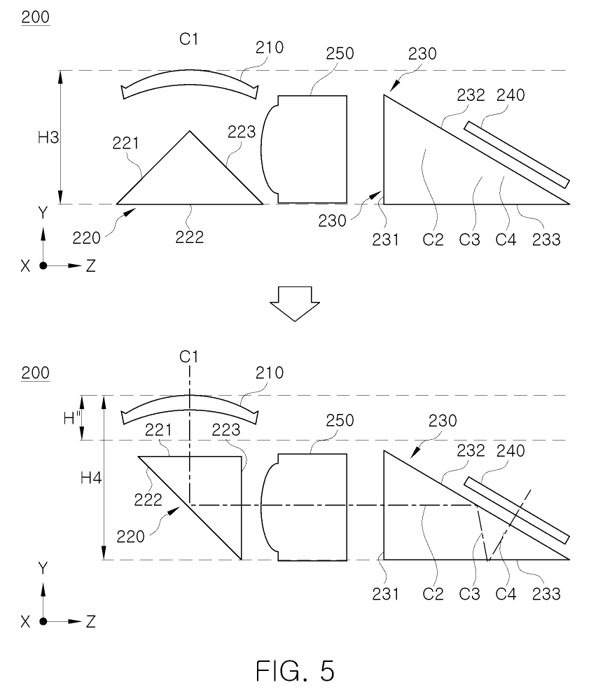

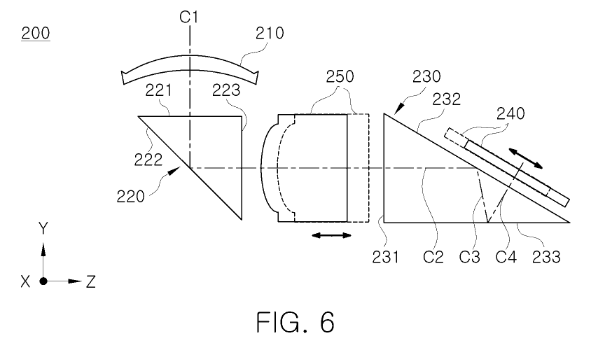

FIG. 5 is a conceptual diagram illustrating a pop-out operation of a camera module according to a second embodiment of the present disclosure, and FIG. 6 is a view illustrating an example of AF and OIS operation of a camera module according to a second embodiment of the present disclosure.

Referring to FIGS. 5 and 6, a camera module 200 may further include a second lens module 250 disposed between a first reflective member 220 and a second reflective member 230.

Light incident on the camera module 200 may pass through a first lens module 210, the first reflective member 220, the second lens module 250, and the second reflective member 230 in sequence, to reach an image sensor 240.

The first reflective member 220 may be a prism including an incident surface 221, a reflective surface 222, and an emission surface 223, and may perform a pop-out operation, together with the first lens module 210. When the first reflective member 220 is in a collapsed position, the reflective surface 222 of the first reflective member 220 may be perpendicular to a first optical axis C1, and when the pop-out operation is performed, the incident surface 221 of the first reflective member 220 may rotate by about 45 degrees to be perpendicular to the first optical axis C1.

In a pop-out position, the incident surface 221 of the first reflective member 220 may be perpendicular to the first optical axis C1, the emission surface 223 may be perpendicular to a second optical axis C2, and the reflective surface 222 may be disposed at a 45-degree angle with respect to the first optical axis C1 and the second optical axis C2. The reflective surface 222 of the first reflective member 220 may approximately face a reflective surface of the second reflective member 230 - a second surface 232 of the second reflective member 230 - in the second optical axis direction (Z-direction).

Referring to FIG. 5, a height of the camera module 200 in the Y-direction may correspond to a distance from a bottom surface of a housing to an object-side surface of the first lens module 210.

In the collapsed position and the pop-out position, a thickness of the first lens module 210 in the Y-direction, and a gap formed between the first lens module 210 and the first reflective member 220 in the Y-direction may be the same. Therefore, in each of the positions, the height of the camera module 200 in the Y-direction may be changed, depending on a height of the first reflective member 220 in the Y-direction.

For example, in the pop-out position, the height of the first reflective member 220 in the Y-direction may correspond to a length of a side of the emission surface 223 having a length in the Y-direction. In the collapsed position, the height of the first reflective member 220 in the Y-direction may correspond to a height of a triangle of which hypotenuse is used as the emission surface 223.

In FIG. 5, H3 may be a maximum height of the camera module 200 in the Y-direction before the first lens module 210 and the first reflective member 220 move upwardly, H4 may be a maximum height of the camera module 200 in the Y-direction after the first lens module 210 and the first reflective member 220 move upwardly, and H” may be a movement distance (displacement) of the first lens module 210 and the first reflective member 220 in the Y-direction.

Referring to FIG. 6, the camera module 200 may adjust focus by moving the second lens module 250, and may perform optical imaging stabilization by moving the image sensor 240. The second lens module 250 may move along the second optical axis direction (Z-direction) between the first reflective member 220 and the second reflective member 230, and the image sensor 240 may perform optical imaging stabilization while moving in major and minor axis directions of the image sensor 240.

According to the present disclosure, a camera module may implement high definition while minimizing a portion protruding outwardly from a mobile device.

The present disclosure aims to provide a camera module with a minimized portion protruding outside of a mobile device.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a first lens module comprising at least one lens disposed in a first optical axis direction and refracting light;
a first reflective member disposed to be spaced apart from the first lens module in the first optical axis direction and configured to change a propagation direction of the light; and
an image sensor disposed to receive the light,
wherein, as the first lens module moves upward along the first optical axis direction, a reflective surface of the first reflective member transitions from a first state of being perpendicular to the first optical axis direction to a second state of being oblique to the first optical axis direction.

2. The camera module of claim 1, wherein, as the first state changes to the second state, a gap between the first lens module and the first reflective member in the first optical axis direction is maintained.

3. The camera module of claim 2, further comprising a first structure having a portion extending in the first optical axis direction, wherein one side of the portion is coupled to the first lens module and another side is coupled to the first reflective member.

4. The camera module of claim 3, wherein the first lens module moves along the first optical axis direction together with the first structure, and
the first reflective member is interlocked with the movement of the first lens module and the first structure to displace a portion of the first reflective member in the first optical axis direction.

5. The camera module of claim 3, wherein the first lens module comprises:
a lens holder on which the at least one lens is mounted;
a carrier accommodating the lens holder; and
a sub-housing accommodating the carrier, and
wherein the first structure is coupled to the sub-housing.

6. The camera module of claim 5, wherein the lens holder is movable in a direction perpendicular to the first optical axis direction with respect to the carrier, and
the carrier is movable in the first optical axis direction, with respect to the sub-housing, together with the lens holder.

7. The camera module of claim 4, wherein one side of the first reflective member is coupled to the first structure and moves together with the first structure, and another side of the first reflective member, disposed in parallel with the one side of the first reflective member, is fixed to a housing.

8. The camera module of claim 7, wherein a guide groove extending in a second optical axis direction perpendicular to the first optical axis direction is disposed in the first structure, and a guide protrusion insertable into the guide groove is disposed on the one side of the first reflective member, and
as the first structure moves along the first optical axis direction, the guide protrusion moves along the second optical axis direction.

9. The camera module of claim 1, further comprising a second reflective member, as a fixed member, disposed between the first reflective member and the image sensor.

10. The camera module of claim 9, wherein the second reflective member redirects the light along at least two changes in the propagation direction.

11. The camera module of claim 10, wherein an angle between the reflective surface of the first reflective member and a second optical axis direction, perpendicular to the first optical axis direction, is greater than an angle between a reflective surface of the second reflective member, which first receives light reflected from the first reflective member, and the second optical axis direction.

12. The camera module of claim 11, wherein the first reflective member is configured to change the propagation direction of the light from the first optical axis direction to the second optical axis direction, perpendicular to the first optical axis direction,
wherein the second reflective member is configured to change the propagation direction of the light from the second optical axis direction to a third optical axis direction, and from the third optical axis direction to a fourth optical axis direction, and
wherein the second optical axis direction, the third optical axis direction, and the fourth optical axis direction are not perpendicular to each other.

13. The camera module of claim 12, wherein an imaging surface of the image sensor is disposed perpendicular to the fourth optical axis direction.

14. The camera module of claim 9, further comprising a second lens module comprising at least one lens disposed in a second optical axis direction perpendicular to the first optical axis direction, and refracting light,
wherein the second lens module is movable between the first reflective member and the second reflective member in the second optical axis direction.

15. The camera module of claim 14, wherein the image sensor is movable in two directions in parallel with an imaging surface of the image sensor and perpendicular to each other.

16. A portable electronic device comprising:
a front surface and a rear surface spaced apart from each other in a thickness direction; and
the camera module of claim 1,
wherein the camera module is disposed between the front surface and the rear surface such that the first optical axis direction aligns with the thickness direction, and
a protrusion amount of the camera module toward either the front surface or the rear surface in the first state is less than a protrusion amount of the camera module toward the front surface or the rear surface in the second state.
